(19) United States
(12) Patent Application Publication
(10) Pub. No.: US 2018/0339588 A1
(43) Pub. Date: Nov. 29, 2018

(54) A VEHICLE THROTTLE SYSTEM

(71) Applicant: AGCO International GmbH, Neuhausen (CH)

(72) Inventor: Philippe HENQUEZ, Beauvais (FR)

(21) Appl. No.: 15/563,066

(22) PCT Filed: Mar. 30, 2016
(86) PCT No.: PCT/EP2016/056943

§ 371 Date: Sep. 29, 2017

(30) Foreign Application Priority Data
Mar. 31, 2015 (EP) 15290089.0

(51) Int. Cl. B60K 26/02; F02D 11/02; F02D 11/10

(52) U.S. Cl. CPC B60K 26/02; F02D 11/02; B60K 2026/046; B60K 2026/029; F02D 11/106

(57) ABSTRACT

A vehicle throttle system having a throttle foot pedal and a throttle lever, wherein actuation of the vehicle engine may be controlled by the pedal and lever. The system includes a throttle level sensor, which is located at the throttle lever, and arranged to receive inputs from both the foot pedal and the lever. By locating the throttle sensor at the throttle lever, the sensor is less exposed to harmful environmental conditions, and can provide for more effective use of vehicle cabin space.

### FIELD OF THE INVENTION

The present invention relates to a throttle system for a vehicle, in particular for an agricultural tractor, and a vehicle having such a throttle system.

### DESCRIPTION OF RELATED ART

In some vehicles, in particular in agricultural tractors, vehicle acceleration can be controlled using a combination of a foot pedal throttle and a hand-operated throttle lever. Such a configuration provides for increased flexibility of control and operator comfort, for example during agricultural field work.

An illustration of a known vehicle throttle system configuration is provided in FIG. 2, wherein a foot pedal 100 is provided pivotally mounted at the floor of a vehicle cab, to allow for motion in the direction of arrow A. The pedal 100 is mechanically linked with a throttle position sensor 102 provided adjacent the pedal 100 by the floor of the vehicle cab. The throttle sensor 102 is linked such that actuation of the pedal 100 results in a corresponding rotational actuation of the sensor 102. This rotational actuation is monitored by the sensor 102 and translated into a desired engine throttle value. The sensor 102 is operable to provide such data either directly to an engine, or to an electronic Engine Control Unit (ECU, not shown), to regulate the operation of the vehicle engine.

The known vehicle throttle system configuration additionally comprises a hand-operated throttle lever 104, which is positioned in the vehicle cab at a location remote to the pedal 100 and throttle sensor 102. The lever 104 may be actuated by an operator as an additional or alternative method of controlling throttle, wherein a movement of the lever 104 in a first direction is translated into an increase in throttle level, and a movement of the lever 104 in a second reverse direction is translated into a reduction in throttle level. The throttle lever 104 projects from a drum 106 and is allowed to rotate about an axis, as indicated by the arrow B in FIG. 2.

In order to translate actuation of the throttle lever 104 into a measurable rotational actuation of the remotely-located sensor 102, a cable 108 is provided which extends between the separate locations of the foot pedal 100 and the throttle lever 104. A guide wire 110 is positioned within the cable 108, the opposite ends of the guide wire 110 secured to a first flange 112 mounted to the foot pedal 100 and to a second flange 114 projecting from the drum 106 of the lever 104. Accordingly, a distinct mechanical connection is provided between the throttle lever 104 and the foot pedal 100.

An actuation of the throttle lever 104 results in a rotation of the second flange 114 of the drum 106, leading to the connected guide wire 110 acting on the first flange 112 through the cable 108 to move the foot pedal 100. As movement of the foot pedal 100 is directly measured by the adjacent throttle sensor 102, accordingly the actuation of the throttle lever 104 can be translated into a throttle control signal to be output from the throttle sensor 102 to control the vehicle engine.

One drawback of this system is that the throttle sensor 102 is prone to damage due to ingress of water or mud, due to the positioning of the sensor 102 towards the base of the vehicle cab. Additionally, the presence of mud or other debris in the cab can impact on the freedom of movement of the foot pedal 100, which can affect the operation of the entire throttle control system. Furthermore, the positioning of the throttle sensor 102 in direct mechanical connection to the pedal 100 imposes physical restrictions on the positioning of the pedal 100 and sensor 102 within the vehicle cab.

An example of an alternative throttle control system can be found in International Patent Application publication WO 96/38682.

It is an object of the invention to provide a vehicle throttle system which addresses the above issues.

### SUMMARY OF THE INVENTION

Accordingly, there is provided a throttle lever assembly for a vehicle throttle system, the throttle lever assembly comprising:

a housing; and

a throttle lever projecting from said housing,

wherein the throttle lever assembly further comprises a throttle level sensor provided on said housing and coupled to said throttle lever, said throttle level sensor further arranged to receive a throttle pedal input from an associated throttle pedal,

the throttle level sensor arranged to output a vehicle throttle level based on an actuation level of the throttle lever and an associated throttle pedal.

Co-locating the throttle level sensor at the throttle lever ensures that the sensor is positioned where it is less exposed to adverse environmental conditions, e.g. debris such as mud or water ingress. In addition, the re-positioning of the throttle sensor can provide for a more effective utilisation of space within a vehicle cab.

Preferably, the throttle lever assembly comprises:

a first rotating key coupled to said lever; and

a second rotating key coupled to an input from a throttle pedal,

said first and second keys arranged to drive an input to said throttle level sensor.

Preferably, said first and second keys are separately actuatable.

Providing separately actuatable keys ensures that actuation of the throttle lever is not translated to actuation of the throttle pedal, and vice versa.

Preferably, the throttle level sensor comprises an input rod, wherein said first and second keys are mounted to said input rod.

Preferably, said throttle lever is mounted on a spindle, the spindle at least partly located within said housing, wherein said spindle acts on said first key to rotate said first key within said housing.

Preferably, the system is configured such that a rotation of the spindle may cause a corresponding rotation of the first key, but a rotation of the first key does not cause a corresponding rotation of the of the spindle.

Preferably, the throttle lever assembly comprises a rotating barrel member located within said housing, said barrel member arranged to receive an input from a throttle pedal, preferably a guide wire coupled to a throttle pedal, wherein said barrel member acts on said second key to rotate said second key within said housing.

Preferably, the system is configured such that a rotation of the barrel member may cause a corresponding rotation of the second key, but a rotation of the second key does not cause a corresponding rotation of the of the barrel member.

Preferably, the throttle lever assembly comprises a guide wire for connection to a throttle pedal.

Preferably, a first end of said guide wire is received in said rotating barrel member and a second end of said guide wire is adapted for connection to a throttle pedal.

Preferably, the guide wire is substantially housed within a cable housing.

Preferably, the throttle lever assembly further comprises at least one spring, wherein at least one of said first and second keys are spring biased to a zero actuation position.

In particular, said second rotating key is spring biased to a zero actuation position to bias an input from a throttle pedal to a zero position.

There is further provided a vehicle throttle system comprising:

a throttle pedal;

a throttle lever; and

a throttle level sensor arranged to output a vehicle throttle level based on an actuation level of the throttle pedal and the throttle lever,

wherein said throttle level sensor is located at said throttle lever.

Preferably, there is provided a vehicle throttle system comprising a throttle lever assembly as described above.

There is further provided a vehicle, preferably an agricultural tractor, having a throttle lever assembly or a vehicle throttle system as described above.

Preferably, the vehicle comprises an Engine Control Unit (ECU), wherein the throttle level sensor is coupled with the ECU.

### BRIEF DESCRIPTION OF THE DRAWINGS

An embodiment of the invention will now be described, by way of example only, with reference to the accompanying drawings, in which:

FIG. 1 is an illustration of an agricultural tractor for use with the system of the invention;

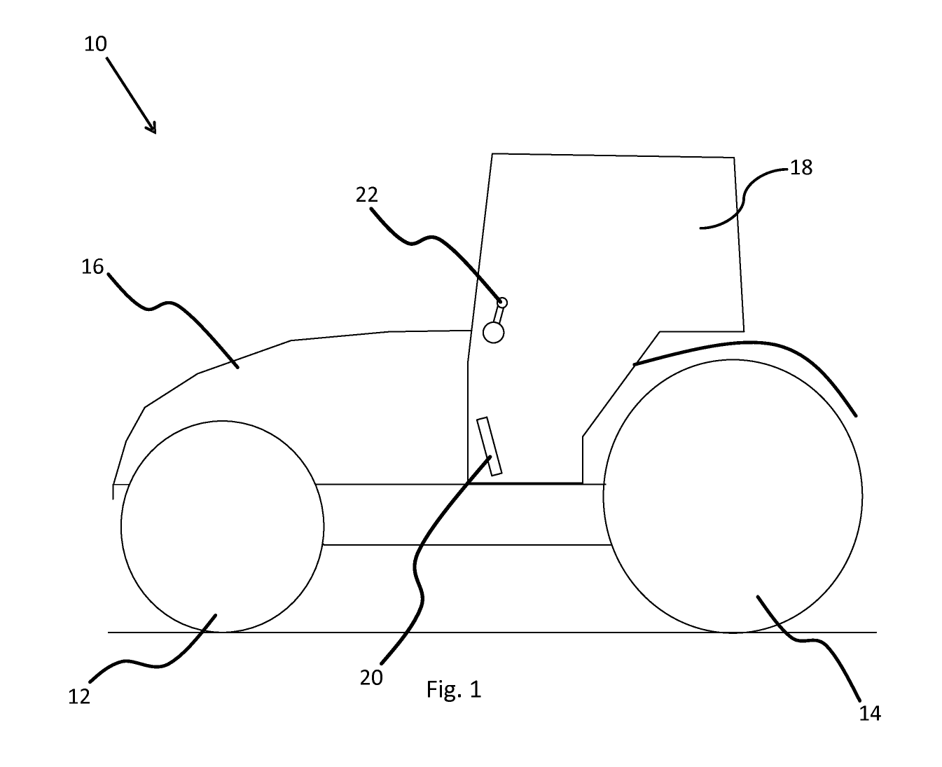

FIG. 2 is an illustration of a known vehicle throttle system;

FIG. 3 is an illustration of a vehicle throttle system according to the invention;

FIG. 4 is an isometric perspective view of a throttle lever assembly according to the invention; and

FIG. 5 is an exploded view of the throttle lever assembly of FIG. 4.

### DETAILED DESCRIPTION OF THE INVENTION

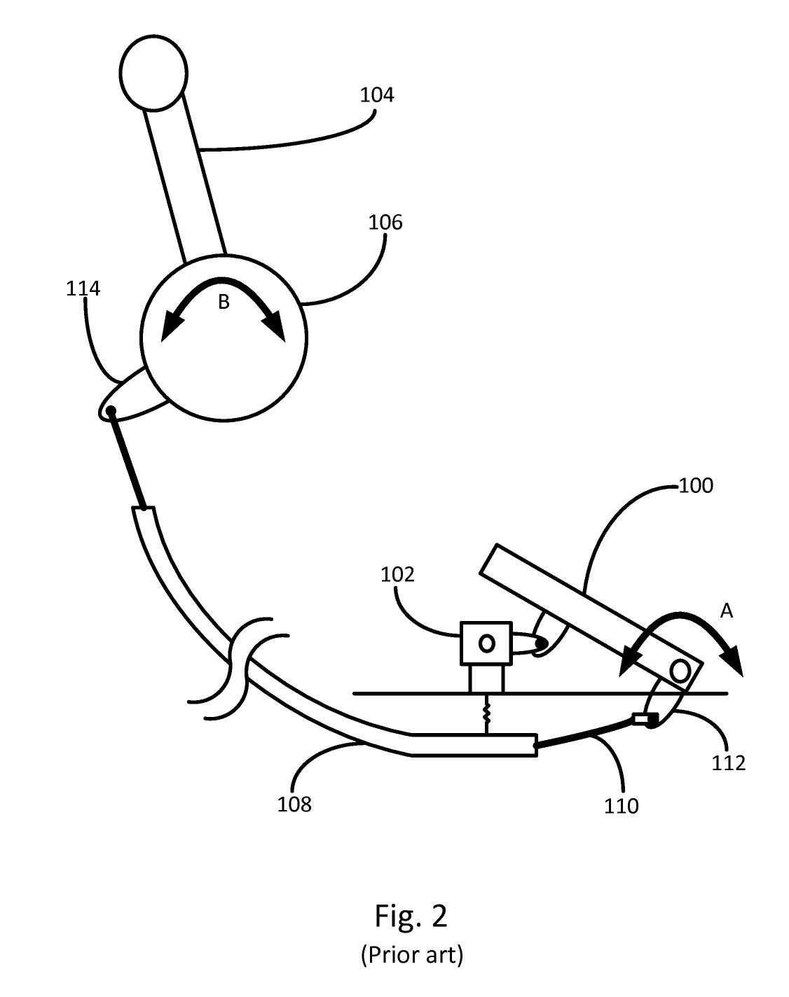

A vehicle in the form of an agricultural tractor is shown in FIG. 2 at 10. The tractor 10 comprises front wheels 12 and rear wheels 14. An engine section 16 is arranged towards the front of the tractor 10, with a cab 18 positioned towards the rear of the tractor 10. The throttle of the tractor engine (not shown) may be controlled by an Engine Control Unit (ECU, not shown). The throttle level can be adjusted through actuation of a throttle foot pedal 20 and/or a hand-operated throttle lever 22, the foot pedal 20 and the throttle lever 22 located in the vehicle cab 18.

An operator can adjust the throttle level applied by the engine through actuation of the foot pedal 20. Similarly, the operator can also adjust the throttle through actuation of the throttle lever 22. The foot pedal 20 and the throttle lever 22 can be used alone or in combination to control the throttle.

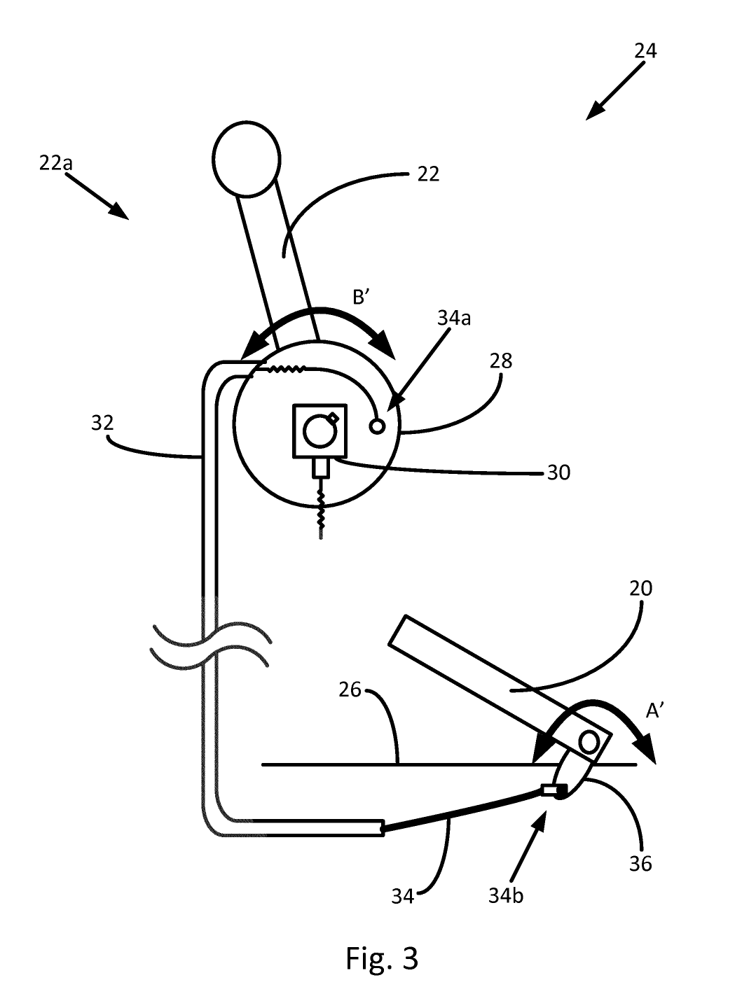

A vehicle throttle system according to the invention is indicated at 24 in FIG. 3. In the system 24, the foot pedal 20 is provided pivotally mounted at the floor 26 of the vehicle cab 18, to allow for motion in the direction of arrow A′. The throttle lever 22 is provided as part of a throttle lever assembly 22a, and positioned in the vehicle cab 18 at a location remote to the pedal 20, preferably provided on a control console, dashboard or armrest assembly located in the cab 18. The throttle lever 22 is mounted to and projects from a main housing 28. The lever 22 is allowed to rotate about an axis, as indicated by the arrow B′ in FIG. 3.

A throttle level sensor 30 is provided at the location of the throttle lever 22, the throttle level sensor 30 communicatively coupled to the ECU. The throttle level sensor 30 is operable to output a signal indicative of a desired throttle level, with which the ECU can control engine operation. The throttle level sensor 30 comprises a rotational sensor, wherein an angle of rotation can be measured to provide a desired throttle level.

The throttle level sensor 30 is provided on the main housing 28 of the throttle lever 22, the sensor 30 coupled with the throttle lever 22, to measure the level of actuation of the lever 22.

The vehicle throttle system 24 further comprises a cable 32 extending between the location of the foot pedal 20 and the location of the throttle lever assembly 22a. The cable 32 houses a guide wire 34. A first end 34a of the guide wire 34 is received within the main housing 28 of the throttle lever assembly 22a, with a second end 34b of the guide wire 34 attached to a flange 36 provided on the foot pedal 20. The system is configured that actuation of the pedal 20 results in movement of the guide wire 34, such that movement of the first end 34a of the guide wire within the main housing 28 of the throttle lever assembly 22a can be measured by the throttle level sensor 30. Positioning the throttle level sensor 30 at the location of the throttle lever assembly 22a means that the sensor is less exposed to harmful environmental conditions, and can provide for more effective utilisation of vehicle cabin space.

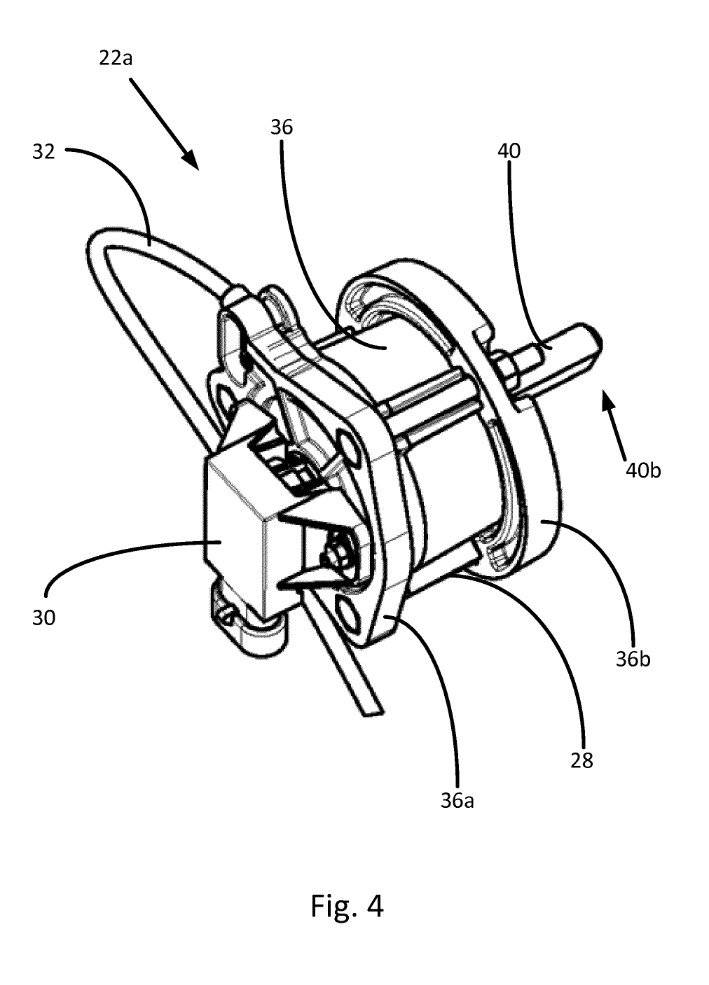

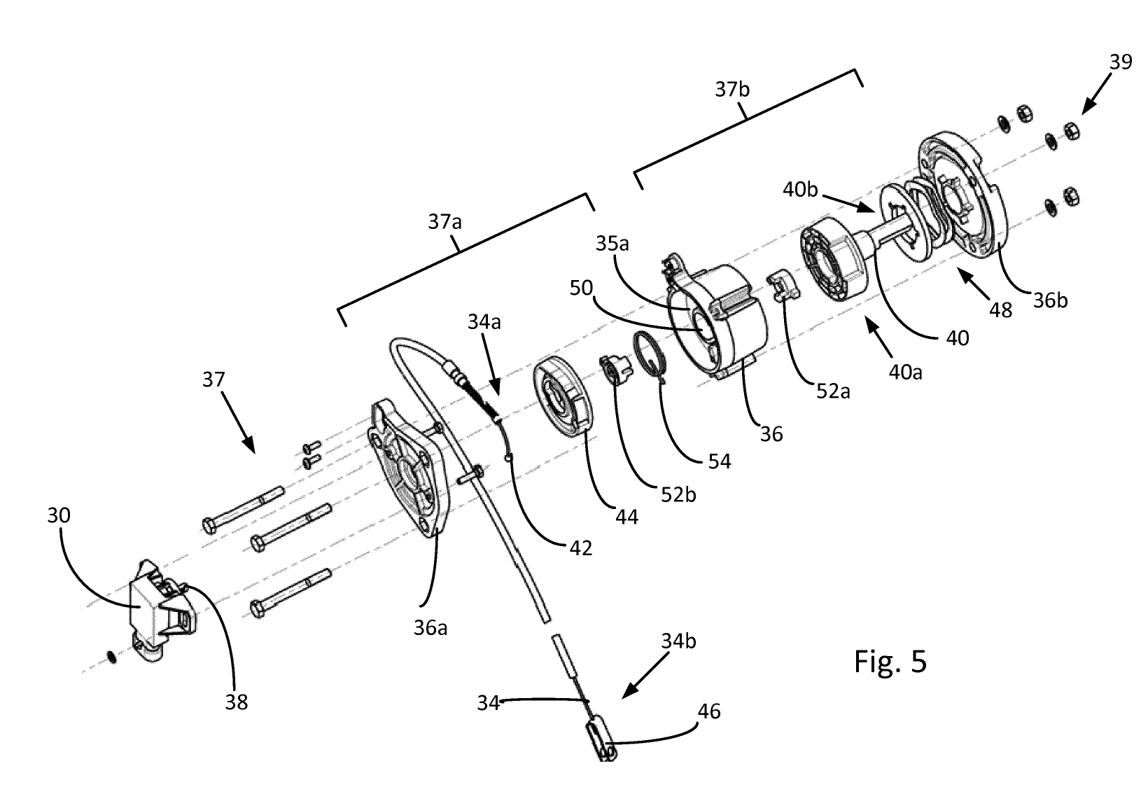

The throttle lever assembly 22a is shown in more detail in FIGS. 4 and 5. The main housing 28 comprises a cylindrical body 35 having first and second end caps 36a, 36b located at opposite sides of the body 36, the body 35 and end caps 36a, 36b assembled together using a series of bolts 37 and associated nut elements 39.

The sensor 30 is mounted to the first end cap 36a at a first side of the housing 28, the sensor 30 comprising an input rod 38 which projects through an aperture provided in the first end cap 36a into the interior of the housing 28. The sensor 30 is operable to monitor the level of rotation of the input rod 38 as a measure of the desired throttle output.

The throttle lever assembly 22a comprises a lever spindle 40 having a first end 40a provided in the interior of the housing 28 and a second end 40b which projects from a second side of the housing 28 through an aperture provided in the second end cap 36b. The throttle lever 22 is arranged to be mounted on the second end 40b of the spindle 40.

The cable housing 32 is coupled with the main housing 28 of the throttle lever assembly 22a, wherein the first end 34a of the contained guide wire 34 is received within the interior of the main housing 28. A spherical end piece 42 is provided at the first end 34a of the guide wire 34, wherein the end piece 42 is coupled with a barrel member 44 positioned within the main housing 28. The second end 34b of the guide wire 34 comprises an attachment flange 46 for coupling to a throttle foot pedal 20. The assembly 22a is arranged wherein a linear movement of the guide wire 34 between the first and second ends 34a, 34b is translated into a rotational movement of the barrel member 44 within the main housing 28 of the assembly 22a.

The cylindrical body 35 comprises an internal wall 35a which divides the interior of the main housing 28 into two separate chambers—a first chamber 37a defined between the first end cap 36a and the internal wall 35a, and a second chamber 37b defined between the second end cap 36b and the internal wall 35a. As indicated in FIG. 5, the barrel member 44 is located within the first chamber 37a, and the first end 40a of the lever spindle 40 is located within the second chamber 37b. Washer elements 48 are also provided in the second chamber 37b, to allow for smooth rotation of the lever spindle 40

A through-going aperture 50 is defined in the internal wall 35a, wherein a first rotating key 52a and a second rotating key 52b are at least partly located in the aperture 48.

The first rotating key 52a is partly positioned within the second chamber 37b, wherein the first end 40a of the lever spindle 40 is arranged to act on the first key 52a to rotate the key 52a within the aperture 50 when the lever 22 is actuated. Similarly, the second rotating key 52b a is partly positioned within the first chamber 37a, wherein the barrel member 44 is arranged to act on the second key 52b to rotate the key 52b within the aperture 50 when the guide wire 34, and by extension when the foot pedal 20, is actuated.

The first and second keys 52a, 52b are located adjacent each other partly in the aperture 50. The keys 52a, 52b are mounted to the input rod 38 of the throttle sensor 30, such that a rotation of the first key 52a or the second key 52b results in a quantifiable rotation of the input rod 38. Accordingly, the throttle level sensor 30 is arranged to output a desired throttle level value, regardless of which key 52a, 52b has been actuated.

The system is configured such that the first and second keys 52a, 52b may be rotated without actuation of the respective lever spindle 40 or barrel member 44. Accordingly, actuation of the throttle lever 22 and associated spindle 40 does not translate into movement of the barrel member 44 and the associated guide wire 34 and foot pedal 20. Similarly, actuation of the foot pedal 22 and the barrel member 44 linked via the guide wire 34 does not translate into movement of the spindle 40 and throttle lever 22. As a result, an operator is able to control the vehicle throttle level through use of the foot pedal 20 and the throttle lever 22, separately or in combination, without impacting on the feel of the controls.

The throttle lever assembly 22a further comprises at least one spring 54 arranged to bias the rotational components of the system to an at-rest or zero position. In the embodiment shown in FIG. 5, the spring 54 is positioned in the first chamber 37a, to bias the second key 52b and the associated barrel member 44 and guide wire 34 to a zero position when not actuated, but it will be understood that additional springs may be used, e.g. to bias the spindle 40.

The invention is not limited to the embodiment described herein, and may be modified or adapted without departing from the scope of the present invention.

1. A throttle lever assembly for a vehicle throttle system, the throttle lever assembly comprising:
a housing;
a throttle lever projecting from said housing; and
a throttle level sensor provided on said housing and coupled to said throttle lever, said throttle level sensor further arranged to receive a throttle pedal input from an associated throttle pedal,
the throttle level sensor arranged to output a vehicle throttle level based on an actuation level of the throttle lever and an associated throttle pedal,
wherein the throttle lever assembly further comprises:
a first rotating key coupled to said lever; and
a second rotating key to be coupled to an input from a throttle pedal,
said first and second keys arranged to drive an input to said throttle level sensor.

2. The throttle lever assembly of claim 1, wherein said first and second keys are separately actuatable.

3. The throttle lever assembly of claim 1, wherein said throttle lever is mounted on a spindle, the spindle at least partly located within said housing, wherein said spindle acts on said first key to rotate said first key within said housing.

4. The throttle lever assembly of claim 1, wherein the throttle lever assembly comprises a rotating barrel member located within said housing, said barrel member arranged to receive an input from a throttle pedal, preferably a guide wire coupled to a throttle pedal, wherein said barrel member acts on said second key to rotate said second key within said housing.

5. The throttle lever assembly of claim 4, wherein the throttle lever assembly comprises a guide wire for connection to a throttle pedal.

6. The throttle lever assembly of claim 5, wherein a first end of said guide wire is received in said rotating barrel member and a second end of said guide wire is adapted for connection to a throttle pedal.

7. The throttle lever assembly of claim 5, wherein the guide wire is substantially housed within a cable housing.

8. The throttle lever assembly of claim 1, wherein the throttle lever assembly further comprises at least one spring, wherein at least one of said first and second keys are spring biased to a zero actuation position.

9. A vehicle throttle system comprising a throttle pedal and a throttle lever assembly as claimed in claim 1.

10. An agricultural vehicle, having a throttle lever assembly as claimed in claim 1.

11. The vehicle of claim 10, wherein the vehicle comprises an Engine Control Unit (ECU), wherein the throttle level sensor is coupled with the ECU to control an engine throttle.
